(19) United States
(12) Patent Application Publication
(10) Pub. No.: US 2024/0378986 A1
(43) Pub. Date: Nov. 14, 2024

(54) DISASTER EVALUATION APPARATUS, DISASTER EVALUATION METHOD, AND NON-TRANSITORY STORAGE MEDIUM

(71) Applicants: NEC Corporation, Tokyo (JP); Tohoku University, Sendai-shi (JP); NEC Solution Innovators, Ltd., Tokyo (JP)

(72) Inventors: Naoki KUWAMORI, Tokyo (JP); Akihiro Musa, Tokyo (JP); Junko Kinjo, Tokyo (JP); Yohei Takigawa, Tokyo (JP); Yoshihiko Satou, Tokyo (JP); Shunichi Kpshimura, Miyagi (JP); Erick Arturo Mas Samanez, Miyagi (JP)

(73) Assignees: NEC Corporation, Tokyo (JP); Tohoku University, Sendai-shi (JP); NEC Solution Innovators, Ltd., Tokyo (JP)

(21) Appl. No.: 18/661,256

(22) Filed: May 10, 2024

(30) Foreign Application Priority Data
May 12, 2023 (JP) 2023-079320

(51) Int. Cl. G08B 25/00; G06Q 50/26

(52) U.S. Cl. CPC G08B 25/00; G06Q 50/265

(57) ABSTRACT

A disaster evaluation apparatus is disclosed. The disaster evaluation apparatus includes at least one memory configured to store an instruction. The disaster evaluation apparatus also includes at least one processor configured to execute the instruction to: respectively perform, in response to occurrence of a disaster, simulations of damage states for plural types of events caused by the disaster; convert data indicating the damage state as each of simulation results by the simulations into data indicating a common social value; and evaluate a change in a social value that is caused by the disaster, based on plural pieces of the converted data.

### INCORPORATION BY REFERENCE

This application is based upon and claims the benefit of priority from Japanese patent application No. 2023-79320, filed on May 12, 2023, the disclosure of which is incorporated herein in its entirety by reference.

### TECHNICAL FIELD

The present disclosure relates to a disaster evaluation apparatus, a disaster evaluation method, and a program that comprehensively evaluate a damage state caused by occurrence of a disaster.

### BACKGROUND ART

A system that appropriately evaluates an amount of losses caused by occurrence of a disaster is known (for example, see Japanese Unexamined Patent Application Publication No. H11-175623 (Patent Literature 1)). A loss evaluation system of Patent Literature 1 effectively evaluates losses expected to be caused by an earthquake.

In the technique described in Patent Literature 1, only an earthquake is exemplified as a type of disaster to be evaluated, and a damage rate is calculated based on an assumed earthquake, and a loss is evaluated based on the damage rate. In addition, a damage rate based on earthquakes, earthquake fires, ground liquefaction phenomena, and the like is calculated only for buildings located in each of regions divided into a mesh shapes, and no consideration is given to cultural damage caused by disasters.

### SUMMARY

The present disclosure is made in order to solve such a problem and an example object of the present disclosure is to provide a disaster evaluation apparatus, a disaster evaluation method, and a program that are capable of comprehensively evaluating a damage state caused by occurrence of a disaster.

In a first example aspect of the present disclosure, a disaster evaluation apparatus includes:
at least one memory configured to store an instruction; and
at least one processor configured to execute the instruction to:
   respectively perform, in response to occurrence of a disaster, simulations of damage states for plural types of events caused by the disaster;
   convert data indicating the damage state as each of simulation results by the simulations into data indicating a common social value; and
   evaluate a change in a social value that is caused by the disaster, based on plural pieces of the converted data.

In a second example aspect of the present disclosure, a disaster evaluation method includes:
respectively performing, in response to occurrence of a disaster, simulations of damage states for plural types of events caused by the disaster;
converting data indicating the damage state as each of simulation results into data indicating a common social value; and
evaluating a change in a social value that is caused by the disaster, based on plural pieces of the converted data of the plurality of simulation results.

In a third example aspect of the present disclosure, a storage medium stores a program causing a computer to execute:
processing of respectively performing, in response to occurrence of a disaster, simulations of damage states for plural types of events caused by the disaster;
processing of converting data indicating the damage state as each of simulation results into data indicating a common social value;
and processing of evaluating a change in a social value that is caused by the disaster, based on plural pieces of the converted data of the plurality of simulation results.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a schematic diagram illustrating a flow from occurrence of a disaster to evaluation of a damage state caused by the disaster;

FIG. 2 is a conceptual diagram illustrating an overall configuration including a disaster evaluation apparatus according to an example embodiment;

FIG. 3 is a block diagram illustrating a configuration of the disaster evaluation apparatus illustrated in FIG. 2;

FIG. 4 is a flowchart illustrating an outline of a disaster damage evaluation processing according to the example embodiment;

FIG. 5 is a conceptual diagram illustrating an input of each simulation unit; and

FIG. 6 is a conceptual diagram illustrating an example of relationships between various simulation units for plural types of events to be executed when an earthquake occurs.

### EXAMPLE EMBODIMENT

### Example Embodiment

Hereinafter, an example embodiment according to the present invention will be explained with reference to the drawings. However, the present disclosure according to the claims is not limited to the following example embodiments. Further, not all of the configurations explained in the present example embodiment are essential as means for solving the problem. For clarity of explanation, the following description and the drawings are omitted and simplified as appropriate. In the drawings, the same elements are denoted by the same reference numerals, and redundant explanations are omitted as necessary.

### <Problems in Disaster Evaluation>

First, problems occurring when evaluating disaster damage and disaster recovery in the present disclosure will be explained. As explained in the background art, a simulation of damage at a time of occurrence of a disaster is often used for estimating details of monetary losses to individual events (for example, a disaster caused by a tsunami and a disaster caused by a flood after an earthquake, a disaster caused by a landslide after a heavy rain or a typhoon passing, a fire caused by a forest fire, and the like), i.e., an amount of losses. Therefore, in the simulation of such damage, it is not possible to comprehensively estimate disaster damage. Hereinafter, a problem of disaster evaluation in the present disclosure will be explained based on the above.

First, there is a problem that there is no uniform evaluation method for disasters. In other words, the damage caused by the disaster includes economic damage that can be converted into an amount of money (for example, the amount of losses caused by collapse of a building, etc.), human damage (for example, how many people have died or injured due to the disaster), cultural damage (for example, disappearance of cultural properties, etc.), and the like. There is a great need for a method of converting integrated value for damage that cannot be converted using these same indicators (for example, an amount of money, etc.).

Second, in a case of simulating a damage state to plural types of events (for example, tsunami and flooding) caused by a disaster, an initial value to be input for a simulation of each event is required. The problem is what initial value should be prepared for the simulation of the damage state for such one or a plurality of events. In addition, there is a desire for the country and local governments to acquire a result of each simulation at an early stage in order to present measures for recovery and reconstruction at an early stage. For example, when an expert conducts a field survey and then, verifies or investigates the damage caused by a disaster and evaluates the disaster that have occurred, it is not a problem to evaluate the disaster thoroughly over a certain amount of time. However, in recent years, a digital twin (disaster digital twin) has been used in order to formulate proposed measures at an early stage, and in this digital twin, a method of responding to a real-time request for a prediction result is required at the time of formulating a disaster countermeasure.

### <Outline of Disaster Evaluation Apparatus of Present Disclosure>

The disaster evaluation apparatus according to the present disclosure has been made to solve the above-described problems. Hereinafter, an outline of the disaster evaluation apparatus according to the present example embodiment in the disaster simulation from the occurrence of a disaster will be explained. The disaster evaluation apparatus, the disaster evaluation method, and the program according to the present disclosure are, in principle, all phenomena occurring when a disaster occurs. The present disclosure is directed to the concept of disaster resilience (resilience and resiliency from disasters).

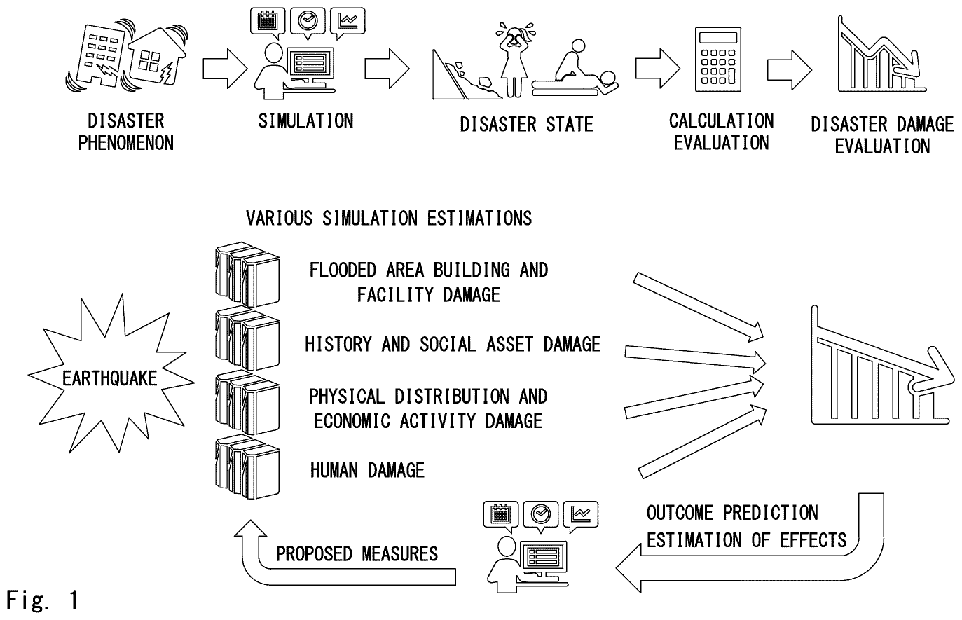

First, evaluation of a damage state at a time of occurrence of a disaster by the disaster evaluation apparatus according to the present disclosure will be explained. Herein, a case where an earthquake occurs as a disaster is exemplified. FIG. 1 is a schematic diagram illustrating a flow from occurrence of a disaster to evaluation of a damage state caused by the disaster. As illustrated in FIG. 1, first, when a disaster (disaster phenomenon) occurs, the disaster evaluation apparatus receives information indicating a scale and occurrence location of the disaster (an epicenter or a depth of the focus) as disaster occurrence information from, for example, a country (government), a response organization (meteorological agency), or the like. In a virtual world of the disaster digital twin, the disaster evaluation apparatus carries out various simulations for the damage state, and estimates the status (damage state) of various types of damage, such as building and facility damage in a flooded area, history and social asset damage, physical distribution and economic activity damage, and human damage.

On the other hand, in a physical world of the disaster digital twin, the disaster evaluation apparatus acquires information regarding an actual damage state in this disaster by sensing a movement or the like of a person or a thing, or collecting information from the country, a local government, or the like.

Next, in the virtual world of the disaster digital twin, the disaster evaluation apparatus comprehensively evaluates the damage caused by this disaster, based on information regarding various estimated damage states, and evaluates a change in social value caused by this disaster. In other words, the disaster evaluation apparatus comprehensively determines simulation results of various simulations, and evaluates and determines how much the social value has fallen due to the disaster.

Next, in the virtual world of the disaster digital twin, the disaster evaluation apparatus may quantify a resilience (durability and restoring force) against a decline in social value from an estimation result of the damage state due to the disaster, formulate a countermeasure (proposed measure) for increasing the resilience, and perform the simulation of the damage state again. As described above, the disaster evaluation apparatus may propose a countermeasure in such a way as to prevent the decline in social value as much as possible by creating a countermeasure and looping a simulation, and by feeding back information regarding the damage state of the physical world. In other words, the disaster digital twin of the present disclosure evaluates the disaster damage by performing a simulation for evaluating a result (damage state) for disaster phenomenon caused by the occurrence of the disaster, estimating the damage state for plural types of events, and comprehensively evaluating the plurality of damage states.

### <Configuration of Disaster Evaluation Apparatus>

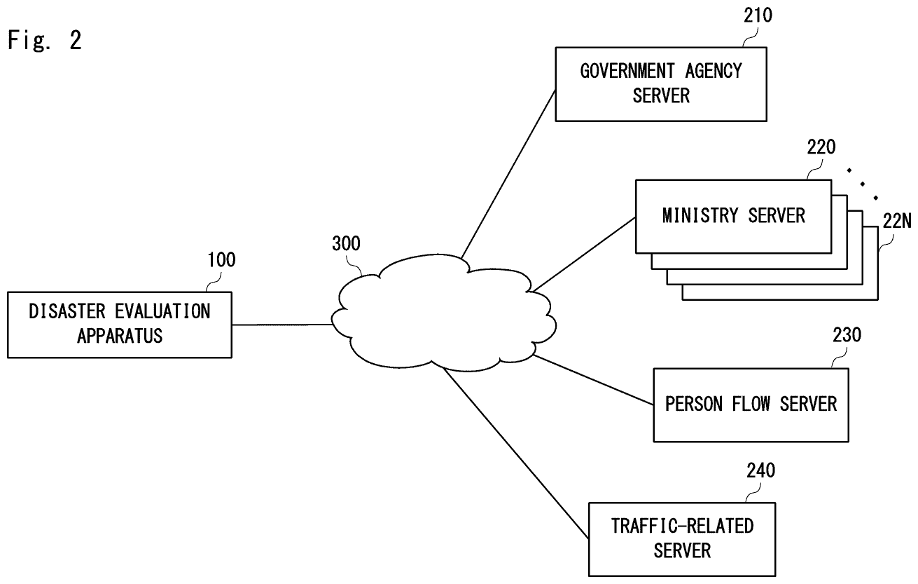

Next, a configuration of the disaster evaluation apparatus according to the present example embodiment will be explained. In the present example embodiment, the disaster evaluation apparatus will be explained as an example of an earthquake and a tsunami that occurs thereafter as a specific example of a disaster, but the type of disaster is not limited thereto. Examples of possible disasters include earthquakes and tsunamis, as well as disasters caused by typhoon and landslides after passing through typhoon, fires caused by forest fires, and disasters caused by heavy rain. First, an overall configuration including the disaster evaluation apparatus will be explained. FIG. 2 is a conceptual diagram illustrating an overall configuration including the disaster evaluation apparatus according to the present example embodiment.

As illustrated in FIG. 2, a disaster evaluation apparatus 100 is connected to a government agency server 210 of a country, respective ministry servers 220 to 22N of the country, a person flow server 230, and a traffic-related server 240 via a network 300 such as the Internet. Herein, the person flow server 230 is a server that provides person flow information within a predetermined region, and may be, for example, a server owned by a communication company (carrier) of a mobile terminal. The traffic-related server 240 may be a server of various types of transportation facilities, and includes, for example, a server of each railway company, a server of each bus company, a server of each airline company, a server of each ship company, and the like.

When a disaster occurs, the disaster evaluation apparatus 100 acquires disaster occurrence information from the government agency server 210 and each of the ministry servers 220 to 22N, as will be described later. For example, when the disaster is an earthquake, the disaster occurrence information includes a scale of the earthquake, a position of an epicenter, a depth of the focus, and the like.

When acquiring information regarding occurrence of the earthquake, the disaster evaluation apparatus 100 is configured to receive seismic intensity information regarding each region affected by the earthquake from Meteorological Agency servers in the ministry servers 220 to 22N and acquire person flow information of the corresponding region from the person flow server 230 for sensing the physical world. Further, the disaster evaluation apparatus 100 is configured to acquire information (traffic-related information) of a traffic network related to the corresponding region from the traffic-related server 240, in particular, destruction information and delay information regarding a railway, departure and arrival information regarding a passenger aircraft, navigation information regarding a ship, and the like. The disaster evaluation apparatus 100 may be configured to always acquire the person flow information and the traffic-related information.

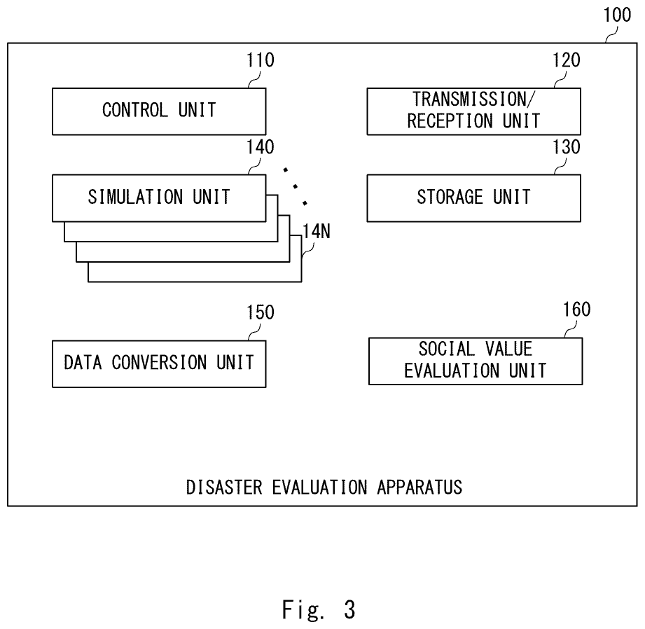

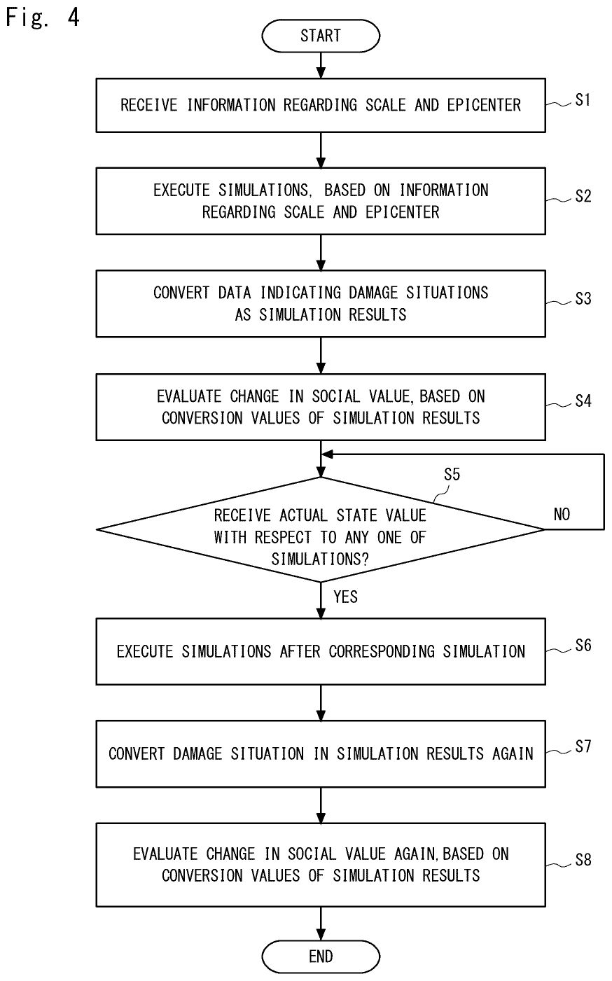

Thereafter, as will be described later, the disaster evaluation apparatus 100 is configured to perform a simulation of a damage state for plural types of events caused by the earthquake, and convert data indicating the damage state as a result of each simulation into data indicating a common social value. Then, the disaster evaluation apparatus 100 is configured to evaluate a change in social value due to the earthquake, based on the plural pieces of converted data. A specific operation of the disaster evaluation apparatus 100 will be described in detail later with reference to a block diagram of FIG. 3 and a flowchart of FIG. 4.

Usually, the social value declines in the event of occurrence of an earthquake. The disaster evaluation apparatus 100 may be configured to recommend a plurality of countermeasures for plural types of events, based on an evaluated degree of social value decline caused by the earthquake. Further, the disaster evaluation apparatus 100 may be configured to transmit the recommendation information to the government agency server 210 or each of the ministry servers 220 to 22N. The country (government) may determine whether to establish a disaster response headquarters, based on the recommended countermeasures, as necessary. In addition, the country (government), local governments in disaster-stricken areas, and the like may determine disaster relief activities to be carried out for residents (disaster victims) in the disaster-stricken areas caused by an earthquake disaster by using these pieces of recommendation information as necessary.

Next, the configuration of the disaster evaluation apparatus 100 according to the present example embodiment will be explained. FIG. 3 is a block diagram illustrating a configuration of the disaster evaluation apparatus 100 illustrated in FIG. 2. While referring to FIGS. 2 and 3, the configuration of the disaster evaluation apparatus 100 according to the present example embodiment will be explained.

As illustrated in FIG. 3, the disaster evaluation apparatus 100 includes a control unit 110, a transmission/reception unit 120, a storage unit 130, a plurality of simulation units 140 to 14N, a data conversion unit 150, and a social value evaluation unit 160. The control unit 110 is configured to control each unit in the disaster evaluation apparatus 100.

The transmission/reception unit 120 is configured to transmit and receive data between the government agency server 210, the ministry servers 220 to 22N, the person flow server 230, and the traffic-related server 240 via the network 300. Specifically, as described above, the transmission/reception unit 120 is configured to receive, after occurrence of a disaster, in this case, an earthquake, disaster occurrence information indicating a scale of the earthquake, a position of the epicenter where the earthquake occurs, and a depth of the focus, from the government agency server 210 and each of the ministry servers 220 to 22N. The transmission/reception unit 120 outputs the received disaster occurrence information to the simulation units 140 to 14N for a simulation of the damage state.

In addition, the transmission/reception unit 120 is configured to receive, from the government agency server 210 and each of the ministry servers 220 to 22N, actual damage state data indicating an actual state value of a damage state in which an actual situation has become clear due to an earthquake. The transmission/reception unit 120 outputs the received actual damage state data to the simulation units 140 to 14N in order to re-simulate the damage state.

Note that the transmission/reception unit 120 may transmit, to the government agency server 210 or the like, data indicating the change in the social value evaluated by the social value evaluation unit 160 in accordance with the occurrence of the earthquake.

The storage unit 130 is configured to temporarily store data indicating a damage state as a simulation result of the plurality of simulation units 140 to 14N, as necessary. The storage unit 130 is configured to temporarily store various pieces of data converted by the data conversion unit 150.

Further, the storage unit 130 is configured to temporarily store the disaster occurrence information and the actual damage state data received by the transmission/reception unit 120 and the data related to the change in the social value evaluated by the social value evaluation unit 160.

The storage unit 130 may be configured to store building and social infrastructure data having a specific added value. Further, the storage unit 130 may be configured to include a database (not illustrated) that stores data of a building and a social infrastructure having a specific added value. The buildings and social infrastructure with specific added value include, for example, historical buildings such as a shrine and a temple, tourist spots such as Tokyo Tower and Skytree, buildings designed by famous architects, suspension bridges such as the Rainbow bridge and the Seto Bridge, and the like. Each of such buildings having a specific added value and the like has a coefficient of losses according to the specific added value and a value recognized by the country or the like, and when the building is destroyed as the historical and social asset damage illustrated in FIG. 1, a higher amount of losses than a normal building is calculated. Note that the transmission/reception unit 120 may be configured to receive such data from, for example, each of the ministry servers 220 to 22N.

The plurality of simulation units 140 to 14N are configured to perform a simulation of a damage state for plural types of events caused by a disaster in response to occurrence of the disaster. Specifically, the plurality of simulation units 140 to 14N are configured to perform a simulation of a damage state for plural types of events, based on the disaster occurrence information received by the transmission/reception unit 120. Each of the simulation units 140 to 14N is configured to output data indicating a damage state as an associated simulation result to other simulation units 140 to 14N related to the simulation unit. As described above, in the disaster evaluation apparatus 100 according to the present example embodiment, the evaluation of the social value by the subsequent social value evaluation unit 160 is estimated by coordinating the plurality of simulation units 140 to 14N.

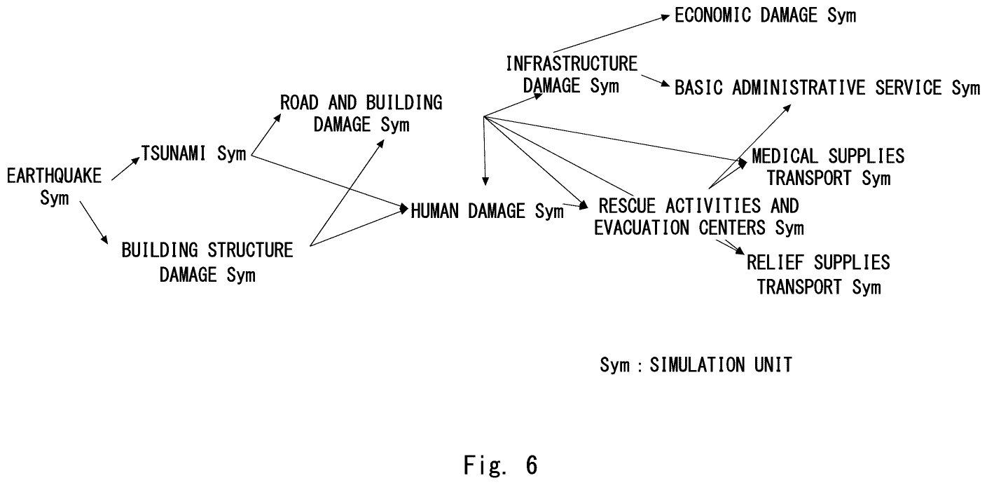

Examples of the plural types of events caused by disasters include, for example, road and building damage, building structure damage, human damage, infrastructure damage, rescue activities and evacuation centers, economic damage, basic administrative services, medical supplies transport, relief supplies transport, and the like, as illustrated in FIG. 6 for an earthquake and a tsunami. FIG. 6 is a conceptual diagram illustrating an example of relationships between various simulation units for plural types of events to be executed when an earthquake occurs.

In the present example embodiment, each of the plurality of simulation units 140 to 14N performs a pertinent simulation for these events when a disaster occurs. Herein, as illustrated in FIG. 6, the plurality of simulation units 140 to 14N include simulation units associated with each other and cooperating with each other, and the simulation unit having such a relationship uses the simulation result of a previous simulation unit as a time series, as an input of a subsequent simulation unit as the time series.

For example, a simulation result of the road building damage simulation unit is used as an input of an infrastructure damage simulation unit, a human damage simulation unit, a rescue activity/evacuation center simulation unit, a medical supplies transport simulation unit, and a relief supplies transport simulation unit.

Regardless of the various simulation units illustrated in FIG. 6, as a specific example, when an earthquake occurs as a disaster, a scale indicated by a magnitude of an earthquake using a seismometer or the like, an epicenter of the earthquake, a depth of the focus, and the like are required. However, since a fault plane of the earthquake is not known, a simulation for calculating the fault plane is executed based on these pieces of information, the seismic intensity of each region, and the like. Then, when the fault plane is found in this simulation, a simulation is executed to calculate how much the sea level has risen in the place. When the sea level rise is recognized by this simulation, a simulation is executed to calculate how the sea level that has risen propagates. Once the propagation of waves (tsunamis) is known, a simulation is performed to calculate when the waves will arrive at the coastal area and how much the above-ground part will be flooded. Once the flooded area is known, a simulation is performed to calculate the extent to which roads, buildings, and infrastructure will be damaged.

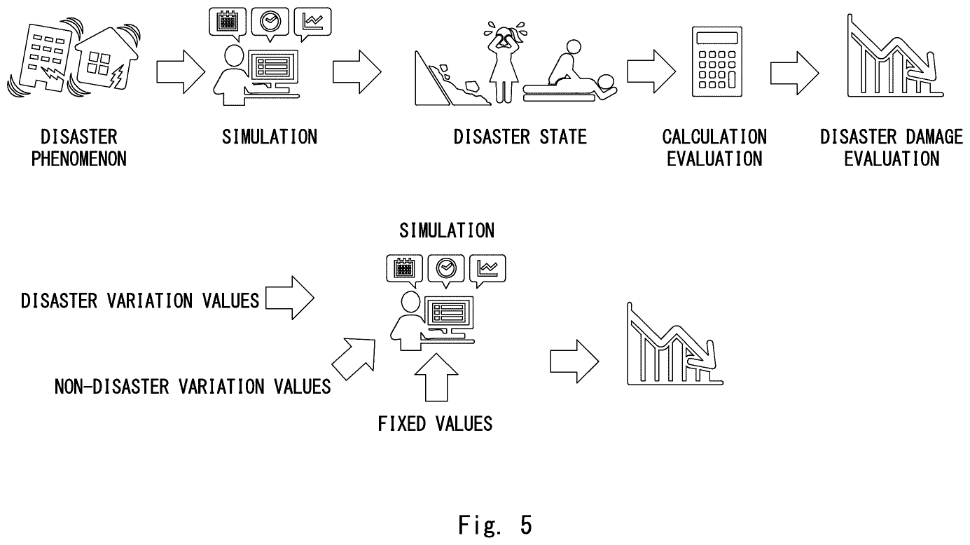

Herein, to each of the plurality of simulation units 140 to 14N, as illustrated in FIG. 5, disaster variation values each of which varies depending on contents of the disaster, non-disaster variation values each of which varies depending on the elapse of time since the occurrence of the disaster regardless of the contents of the disaster, and fixed values that hardly vary depending on the contents of the disaster are input as input values. FIG. 5 is a conceptual diagram illustrating inputs of the simulation units 140 to 14N.

Each of the disaster variation values is a value (for example, the scale and occurrence place of the earthquake, the mechanism thereof, and the like) that is originally clarified by the investigation, and is acquired from the various servers 210, 220 to 22N, and the like via the network 300 and the transmission/reception unit 120. Each of the non-disaster variation values is a value (for example, temperature and humidity, the number of people at a certain place in a certain time zone, a sickbed usage rate, and the like) that is always collected and can be sensed regardless of a disaster, and is acquired from various servers 220 to 22N, 230, 240, and the like via the network 300 and the transmission/reception unit 120. Each of the fixed values is a value having a relatively low variation frequency (for example, a terrain, a facility building, a physical coefficient, and the like), and is stored in advance in the storage unit 130, for example. In addition, the fixed values may include the maximum number of accepted patients of each medical facility, the location of each facility, the location of each infrastructure installation, and the like.

In addition, the data indicating the damage states as the plurality of simulation results of the plurality of simulation units 140 to 14N include data that can be converted as an amount of losses, data that indicate the damage state due to the occurrence of a disaster with respect to the reference state as a relative evaluation, data that are acquired by adding weights to a plurality of evaluation values, data that are based on ranking, and data that are based on the number of evaluation values of the same degree.

Data that can be converted as an amount of losses mean the same standard conversion data, and the acquired numerical value may be converted into a common value (herein, sum of money such as an amount of losses). The data indicating the damage state due to the occurrence of a disaster with respect to the reference state as a relative evaluation mean the reference state relative conversion data, and specifically, the reference state may be set, the value state from each viewpoint may be evaluated relative to the reference state, and the reference state ratio value may be acquired. For example, a positive value is set when the reference state becomes better, and a negative value is set when the reference state becomes worse. Then, the data indicate whether it is a positive value or a negative value with respect to the reference state by calculating these degrees of positive and negative.

The data acquired by weighting and adding a plurality of evaluation values mean weighted conversion data, and specifically, it is only necessary to multiply different evaluation values by weighted counts, add the resultants, and acquire the data. For example, a satisfaction level of a questionnaire to be described later, or the like is included. The data based on ranking mean rank conversion data, and it is only necessary to rank a plurality of objects having the same structure for data that are difficult to perform absolute evaluation, ratio evaluation, or relative evaluation. The data are acquired by, for example, a difference or a rank when a similar type but another phenomenon occurs. Specifically, the case is determined based on a population difference within a region, the number per population, and the number of administrative facilities within the region (the number of nursery schools and schools, the number of children parks, and the like). The data based on the number of evaluation values of the same degree mean so-called ox number-conversion data, and may be acquired by counting the number of objects having the same value.

Note that each of the plurality of simulation units 140 to 14N may be configured to perform a simulation of a damage state with respect to a target event according to a time series from a time of occurrence of a disaster. Each of the plurality of simulation units 140 to 14N may receive, as input values, data indicating a damage state as a simulation result performed by the other simulation units 140 to 14N that have simulated the damage state with respect to one or a plurality of events that has occurred before the event as a time series of the target event.

In addition, in a case where the transmission/reception unit 120 receives the actual damage state data indicating an actual state value of the damage state in which the actual situation has become clear due to a disaster, the actual damage state data received by the transmission/reception unit 120 may be input to each of the other simulation units 140 to 14N at a later stage in time series than the corresponding simulation units 140 to 14N, instead of the data indicating the damage state as the simulation result of the corresponding simulation units 140 to 14N.

When the storage unit 130 stores data of a building and a social infrastructure having a specific added value, the plurality of simulation units 140 to 14N at least include a road building damage simulation unit that performs a simulation of a damage state of a road and a building, and an infrastructure damage simulation unit that performs a simulation of a damage state of a social infrastructure. Then, the road building damage simulation unit and the infrastructure damage simulation unit may perform a simulation of the damage state in consideration of the specific added value on the building and the social infrastructure having the specific added value that are stored in the storage unit 130.

The data conversion unit 150 is configured to convert data indicating a damage state as a simulation result of each of the plurality of simulation units 140 to 14N into data indicating a common social value. The plural pieces of data converted by the data conversion unit 150 are output to the social value evaluation unit 160.

Further, as described above, the data conversion unit 150, when the data indicating the damage state is evaluated by a plurality of different evaluation methods (loss amount conversion, reference state relative conversion, etc.), is configured to convert plural pieces of data evaluated by different evaluation methods into plural pieces of data indicating a common social value.

Further, when transmission/reception unit 120 receives the actual damage state data indicating the actual state value of the damage state in which the actual situation has become clear, the data conversion unit 150 may convert the actual damage state data into data indicating a common social value, and convert the data indicating the damage state as new simulation results of the simulation units 140 to 14N to which the actual damage state data are input and the other simulation units 140 to 14N related to the corresponding simulation units 140 to 14N into data indicating a common social value again. As a result, the damage state becomes clear each time the time is followed, and the simulation results of the simulation units 140 to 14N become more accurate.

The social value evaluation unit 160 is configured to evaluate a change in social value due to a disaster, based on plural pieces of data converted by the data conversion unit 150. The transmission/reception unit 120 may transmit the change in the social value evaluated by the social value evaluation unit 160 (a change in the negative value in the event of a disaster) to the government agency server 210 or each of the ministry servers 220 to 22N.

When the transmission/reception unit 120 receives the actual damage state data indicating the actual state value of the damage state in which the actual situation has become clear, the simulation units 140 to 14N output the new simulation result, and the data conversion unit 150 executes the conversion again, the social value evaluation unit 160 may evaluate the change in the social value due to the disaster again, based on the conversion value of the actual damage state data received by the transmission/reception unit 120 and the data indicating the common social value that has been converted again by the data conversion unit 150. The social value evaluation unit 160 can reevaluate the social value according to an actual damage situation by reevaluating the social value change through use of the conversion value based on the actual damage state data, and can also recommend a countermeasure that matches the actual state of the disaster when necessary.

Herein, an outline of a series of operations of the disaster evaluation apparatus 100 will be explained. In accordance with the disaster state after the occurrence of the disaster, the plurality of simulation units 140 to 14N perform various simulations, and output data indicating the damage state and the recovery state as the simulation result.

The data conversion unit 150 converts each piece of data into data indicating a common social value, and the social value evaluation unit 160 evaluates a change in social value due to a disaster, based on a plurality of the converted data. Herein, the control unit 110 may cause the plurality of simulation units 140 to 14N to perform error calculation optimization processing in such a way that the evaluation result of the social value evaluation unit 160 becomes as high as possible.

The error calculation optimization processing is processing of shifting data to be input to each of the plurality of simulation units 140 to 14N little by little and acquiring an evaluation result of the social value evaluation unit 160 each time. By optimizing the evaluation result, it is possible to suppress a decline in social value in the damage state. It is only possible to acquire such a simulation result by performing comprehensive evaluation by the social value evaluation unit 160.

Specifically, in the error calculation optimization processing, the control unit 110 determines a difference in the acquired social value by the social value evaluation unit 160 evaluating the change in the social value while changing contents of the rescue, relief, and restoration in the plurality of simulation units 140 to 14N. Then, the control unit 110 calculates a relative difference with the social value expected at the time of occurrence of a disaster, and searches for an optimum solution while performing counting correction in such a way that the social value is optimized. As a search method of the optimum solution, a conventional method such as an error random number optimization method or a comprehensive calculation method may be adopted.

Then, the disaster evaluation apparatus 100 may recommend correction of measures and countermeasures by the country or each local government, based on the contents of the rescue, relief, and restoration which are the optimum solutions determined by the error calculation optimization processing by the control unit 110.

By configuring the social value evaluation unit 160 as described above, a relatively integrated determination result (evaluation result) can be acquired at an early stage, and a plurality of countermeasures can be prioritized and proposed based on a change in the evaluated social value. Therefore, according to the disaster evaluation apparatus 100, it is possible to support the political judgment of the general judge who is the head of each local government in the country or the disaster-stricken area.

The digital twin used for disasters, which has been used so far, has been used only to simulate the damage state caused by disasters and to evaluate the state and situation of the damage caused by disasters as a result of the simulation. According to the disaster evaluation apparatus 100 of the present example embodiment, as described above, it is possible to comprehensively evaluate the damage state caused by the disaster. Then, in order to evaluate the resilience of the whole society to the damage, it is possible to evaluate the social value comprehensively by efficiently fusing numerical values and the like as simulation results acquired from simulations for plural types of events.

Further, according to the disaster evaluation apparatus 100 of the present example embodiment, in consideration of execution of a plurality of simulations according to a time series, data indicating an actual state value of a damage state in which an actual situation has become clear is fed back. Then, by performing the simulation again by the related simulation units 140 to 14N after the corresponding simulation units 140 to 14N, it is possible to correct an error of the simulation result by the plurality of simulation units 140 to 14N, and thereby it is possible to effectively prevent the evaluation of the social value evaluation unit 160 from being overestimated.

When the initial simulation results acquired by each of the plurality of simulation units 140 to 14N and actual state values of the damage state and the restoration state in which the actual situation has become clear are deviated from each other beyond the allowable range, the control unit 110 may be configured to review the coefficients and the like of the simulation in the corresponding simulation units 140 to 14N. This makes it possible to more accurately evaluate a change in social value due to disasters in the initial stage.

### <Operation of Disaster Evaluation Apparatus>

Next, an operation of the disaster evaluation apparatus 100 according to the present example embodiment will be explained with reference to FIG. 4.

First, evaluation of a damage state when a disaster occurs will be explained. FIG. 4 is a flowchart illustrating an outline of disaster damage evaluation processing according to the present example embodiment. The disaster damage evaluation processing is started, for example, when a disaster occurs and disaster occurrence information is provided from the government agency server 210 or each of the ministry servers 220 to 22N. Herein, the operation of the disaster evaluation apparatus 100 in a case where an earthquake occurs as a disaster will be explained in the same manner as described above.

Upon receiving the provision of the disaster occurrence information, the disaster evaluation apparatus 100 requests the government agency server 210 and the ministry servers 220 to 22N to transmit information related to the disaster via the transmission/reception unit 120. Then, the transmission/reception unit 120 receives information (disaster occurrence information) regarding a scale of an earthquake and epicenter (step S1), and outputs the received information to the plurality of simulation units 140 to 14N. Each of the plurality of simulation units 140 to 14N executes a simulation of a damage state with respect to an associated event according to the time series, based on the information regarding the scale of the earthquake, the epicenter thereof, and the like (step S2). Each of the simulation units 140 to 14N outputs the data indicating the damage state as the simulation result to the other simulation units 140 to 14N in the subsequent stage as it is, and outputs the data to the data conversion unit 150 as necessary. Upon receiving the data indicating the damage state from the simulation units 140 to 14N, the data conversion unit 150 converts the plural pieces of data respectively indicating the damage states as the simulation result of the associated simulation units 140 to 14N into the data indicating a common social value (step S3).

When necessary, the data conversion unit 150 outputs data (conversion value) indicating the converted social value to the other simulation units 140 to 14N in the subsequent stage, and also outputs the data to the social value evaluation unit 160 in the similar manner. Upon receiving the data indicating the social value converted by the data conversion unit 150 with respect to the simulation results of all of the simulation units 140 to 14N, the social value evaluation unit 160 evaluates the change in the social value due to the disaster, based on the plural pieces of data (step S4).

Although omitted in the flowchart of FIG. 4, the disaster evaluation apparatus 100 may transmit the evaluation result to the government agency server 210 or the like via the transmission/reception unit 120 and the network 300 at a stage when the change in the social value due to the disaster is evaluated.

Next, the control unit 110 determines whether the transmission/reception unit 120 has received, from any of the ministry servers 220 to 22N or the like, actual damage state data indicating an actual state value of a damage state associated to any one of the plurality of simulation results of the plurality of simulation units 140 to 14N (step S5). The disaster evaluation apparatus 100 waits in this step S5 until receiving the actual damage state data by the transmission/reception unit 120.

When the control unit 110 determines that any of the actual damage state data has been received by the transmission/reception unit 120, the transmission/reception unit 120 outputs the received actual damage state data to the subsequent simulation units 140 to 14N in time series related to the associated simulation units 140 to 14N. Then, the simulation units 140 to 14N that have received the actual damage state data execute their own simulation again, and output data indicating the damage state as a new simulation result to the other related simulation units 140 to 14N in the subsequent stage. The other related simulation units 140 to 14N in the subsequent stage similarly execute their own simulation again, and thereby the simulations of the corresponding simulation units 140 to 14N is executed (step S6).

Next, similarly to the processing of step S3, the data conversion unit 150 converts the data indicating the damage state as the simulation result of the simulation units 140 to 14N that have executed the simulation again into the data indicating the common social value again (step S7). Then, the social value evaluation unit 160 evaluates the change in the social value due to the disaster again, based on plural pieces of data including the data converted again (conversion value) (step S8).

Then, the control unit 110 ends the disaster damage evaluation processing. Although omitted in the flowchart of FIG. 4, each time a change in social value due to a disaster is reevaluated, the disaster evaluation apparatus 100 may transmit the reevaluation result to the government agency server 210 or the like via the transmission/reception unit 120 and the network 300.

Although the types of actual damage state data that can be acquired depending on the types of disasters to be simulated are different, after the disaster damage evaluation processing is started, the disaster evaluation apparatus 100 may repeat the processing of steps S5 to S8 of the disaster damage evaluation processing until all the actual damage state data are received by the transmission/reception unit 120.

As explained above, the disaster evaluation apparatus 100 according to the present example embodiment includes a plurality of simulation units 140 to 14N that simulate a damage state for plural types of events caused by a disaster in response to the occurrence of a disaster, a data conversion unit 150 that converts data indicating a damage state as a result of a simulation of each of the plurality of simulation units 140 to 14N into data indicating a common social value, and a social value evaluation unit 160 that evaluates a change in social value due to a disaster, based on the plural pieces of data converted by the data conversion unit 150. By configuring the disaster evaluation apparatus 100 in this way, the data indicating the damage state as a plurality of simulation results is converted into data indicating a common social value, since the social value is evaluated based on it, it is possible to comprehensively evaluate the damage state due to the occurrence of the disaster.

The disaster evaluation method according to the present example embodiment includes: performing, in response to occurrence of a disaster, a simulation of a damage state for plural types of events caused by a disaster; converting data indicating the damage state as a plurality of simulation results into data indicating a common social value; and evaluating a change in social value due to the disaster, based on the plurality of converted data. As a result, the same effects as those of the disaster evaluation apparatus 100 can be acquired.

Part or all of the processing in the disaster evaluation apparatus 100 described above can be achieved as a computer program. Such a program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been explained with reference to the example embodiments, the present disclosure is not limited to the above-described example embodiments, and can be appropriately modified without departing from the gist thereof.

Some or all of the above-described example embodiments may be described as the following supplementary notes, but are not limited thereto.

### Supplementary Note 1

A disaster evaluation apparatus including:
a plurality of simulation units configured to respectively perform, in response to occurrence of a disaster, simulations of damage states for plural types of events caused by the disaster;
a data conversion unit configured to convert data indicating the damage state as each of simulation results by the plurality of simulation units into data indicating a common social value; and
a social value evaluation unit configured to evaluate a change in a social value that is caused by the disaster, based on plural pieces of data converted by the data conversion unit.

### Supplementary Note 2

The disaster evaluation apparatus according to supplementary note 1, wherein
the data indicating the damage state as the plurality of simulation results of the plurality of simulation units include data that can be converted as an amount of losses, data indicating a damage state due to the disaster occurrence with respect to a reference state as a relative evaluation, data acquired by weighting and adding a plurality of evaluation values, data based on ranking, and data based on a number of evaluation values each having a same degree, and
the data conversion unit converts plural pieces of data evaluated by different evaluation methods into plural pieces of data indicating the common social value.

### Supplementary Note 3

The disaster evaluation apparatus according to supplementary note 1, wherein
each of the plurality of simulation units receives, as input values, an input of a disaster variation value that varies depending on a content of the disaster, a non-disaster variation value that varies depending on a lapse of time from occurrence of the disaster regardless of a content of the disaster, and a fixed value that hardly vary depending on a content of the disaster.

### Supplementary Note 4

The disaster evaluation apparatus according to supplementary note 1, wherein
each of the plurality of simulation units performs the simulation of the damage state for the event according to a time series from a time of the occurrence of the disaster, and
each of the plurality of simulation units receives, as input values, an input of data indicating a damage state as a simulation result of another simulation unit that simulates the damage state for one or a plurality of events occurring before the event as the time series of the target event.

### Supplementary Note 5

The disaster evaluation apparatus according to supplementary note 4, further including:
a transmission/reception unit configured to receive actual damage state data indicating an actual state value of the damage state that has been caused by the disaster and reveals an actual situation,
wherein each of the plurality of simulation units receives an input of the actual damage state data received by the transmission/reception unit, in place of the data indicating the damage state as the simulation result of the another simulation unit.

### Supplementary Note 6

The disaster evaluation apparatus according to supplementary note 5, wherein
the data conversion unit converts the actual damage state data into data indicating a common social value, and converts data indicating the damage state as a new simulation result of the simulation unit to which the actual damage state data are input and the other simulation unit related to the corresponding simulation unit into data indicating the common social value again, and
the social value evaluation unit reevaluates the change in the social value due to the disaster, based on a conversion value of the actual damage state data received by the transmission/reception unit and the data indicating the common social value converted again by the data conversion unit.

### Supplementary Note 7

The disaster evaluation apparatus according to supplementary note 5, wherein
the transmission/reception unit receives disaster occurrence information indicating a scale and an occurrence location of the disaster after the disaster occurs, and
the plurality of simulation units respectively perform the simulations of the damage states for the plural types of events, based on the disaster occurrence information received by the transmission/reception unit.

### Supplementary Note 8

The disaster evaluation apparatus according to supplementary note 1, wherein
in a case where the disaster is a disaster caused by an earthquake and a subsequent tsunami, the damage caused by the disaster includes building and facility damage in a flooded area, history and social asset damage, physical distribution and economic activity damage, and human damage.

### Supplementary Note 9

The disaster evaluation apparatus according to supplementary note 8, further including:
a storage unit configured to store data of a building and a social infrastructure each having a specific added value, wherein
the plurality of simulation units include at least a road building damage simulation unit configured to perform a simulation of a damage state of a road and a building, and an infrastructure damage simulation unit configured to simulate a damage state of a social infrastructure, and
the road building damage simulation unit and the infrastructure damage simulation unit respectively perform the simulations of the damage states in consideration of the specific added value on the building and the social infrastructure having the specific added value that are stored in the storage unit.

### Supplementary Note 10

A disaster evaluation method including:
respectively performing, in response to occurrence of a disaster, simulations of damage states for plural types of events caused by the disaster;
converting data indicating the damage state as each of simulation results into data indicating a common social value; and
evaluating a change in a social value that is caused by the disaster, based on plural pieces of the converted data of the plurality of simulation results.

### Supplementary Note 11

A storage medium storing a program causing a computer to execute:
processing of respectively performing, in response to occurrence of a disaster, simulations of damage states for plural types of events caused by the disaster;
processing of converting data indicating the damage state as each of simulation results into data indicating a common social value; and
processing of evaluating a change in a social value that is caused by the disaster, based on plural pieces of the converted data of the plurality of simulation results.

What is claimed is:

1. A disaster evaluation apparatus comprising:
at least one memory configured to store an instruction; and
at least one processor configured to execute the instruction to:
respectively perform, in response to occurrence of a disaster, simulations of damage states for plural types of events caused by the disaster;
convert data indicating the damage state as each of simulation results by the simulations into data indicating a common social value; and
evaluate a change in a social value that is caused by the disaster, based on plural pieces of the converted data.

2. The disaster evaluation apparatus according to claim 1, wherein
the data indicating the damage state as the plurality of simulation results by the simulations include data that can be converted as an amount of losses, data indicating a damage state due to the disaster occurrence with respect to a reference state as a relative evaluation, data acquired by weighting and adding a plurality of evaluation values, data based on ranking, and data based on a number of evaluation values each having a same degree, and
the at least one processor is configured to convert plural pieces of data evaluated by different evaluation methods into plural pieces of data indicating the common social value.

3. The disaster evaluation apparatus according to claim 1, wherein
the at least one processor is configured to receive, as input values, an input of a disaster variation value that varies depending on a content of the disaster, a non-disaster variation value that varies depending on a lapse of time from occurrence of the disaster regardless of a content of the disaster, and a fixed value that hardly vary depending on a content of the disaster.

4. The disaster evaluation apparatus according to claim 1, wherein
the at least one processor is configured to perform the simulation of the damage state for the event according to a time series from a time of the occurrence of the disaster, and
the at least one processor is configured to receive, as input values, an input of data indicating a damage state as a simulation result of another simulation of simulating the damage state for one or a plurality of events occurring before the event as the time series of the target event.

5. The disaster evaluation apparatus according to claim 4, further comprising:
a transmitter/receiver configured to receive actual damage state data indicating an actual state value of the damage state that has been caused by the disaster and reveals an actual situation,
wherein the at least one processor is configured to receive an input of the actual damage state data received by the transmitter/receiver, in place of the data indicating the damage state as the simulation result of the another simulation.

6. The disaster evaluation apparatus according to claim 5, wherein
the at least one processor is configured to convert the actual damage state data into data indicating a common social value, and convert data indicating the damage state as a new simulation result of the simulation for which the actual damage state data are input and the other simulation related to the corresponding simulation into data indicating the common social value again, and
the at least one processor is configured to reevaluate the change in the social value due to the disaster, based on a conversion value of the actual damage state data received by the transmitter/receiver and the data indicating the common social value thus converted again.

7. The disaster evaluation apparatus according to claim 5, wherein
the transmitter/receiver receives disaster occurrence information indicating a scale and an occurrence location of the disaster after the disaster occurs, and
the at least one processor is configured to perform the simulations of the damage states for the plural types of events, based on the disaster occurrence information received by the transmitter/receiver.

8. The disaster evaluation apparatus according to claim 1, wherein
in a case where the disaster is a disaster caused by an earthquake and a subsequent tsunami, the damage caused by the disaster includes building and facility damage in a flooded area, history and social asset damage, physical distribution and economic activity damage, and human damage.

9. The disaster evaluation apparatus according to claim 8, further comprising:
a storage configured to store data of a building and a social infrastructure each having a specific added value, wherein
the plurality of simulations includes at least a road building damage simulation to perform a simulation of a damage state of a road and a building, and an infrastructure damage simulation to simulate a damage state of a social infrastructure, and
the at least one processor is configured to perform the simulations of the damage states in consideration of the specific added value on the building and the social infrastructure having the specific added value that are stored in the storage.

10. A disaster evaluation method comprising:
respectively performing, in response to occurrence of a disaster, simulations of damage states for plural types of events caused by the disaster;
converting data indicating the damage state as each of simulation results into data indicating a common social value; and
evaluating a change in a social value that is caused by the disaster, based on plural pieces of the converted data of the plurality of simulation results.

11. The disaster evaluation method according to claim 10, wherein
the data indicating the damage state as the plurality of simulation results by the simulations include data that can be converted as an amount of losses, data indicating a damage state due to the disaster occurrence with respect to a reference state as a relative evaluation, data acquired by weighting and adding a plurality of evaluation values, data based on ranking, and data based on a number of evaluation values each having a same degree, and
plural pieces of data evaluated by different evaluation methods are converted into plural pieces of data indicating the common social value.

12. The disaster evaluation method according to claim 10, further comprising:
as input values, inputting a disaster variation value that varies depending on a content of the disaster, a non-disaster variation value that varies depending on a lapse of time from occurrence of the disaster regardless of a content of the disaster, and a fixed value that hardly vary depending on a content of the disaster.

13. The disaster evaluation method according to claim 10, wherein
the simulation of the damage state for the event according to a time series from a time of the occurrence of the disaster is performed, and
the method further comprises:
inputting, as input values, data indicating a damage state as a simulation result of another simulation of simulating the damage state for one or a plurality of events occurring before the event as the time series of the target event.

14. The disaster evaluation method according to claim 13, further comprising:
receiving actual damage state data indicating an actual state value of the damage state that has been caused by the disaster and reveals an actual situation; and
inputting the actual damage state data thus received in place of the data indicating the damage state as the simulation result of the another simulation.

15. The disaster evaluation method according to claim 14, further comprising:
converting the actual damage state data into data indicating a common social value;
converting data indicating the damage state as a new simulation result of the simulation for which the actual damage state data are input and the other simulation related to the corresponding simulation into data indicating the common social value again; and
reevaluating the change in the social value due to the disaster, based on a conversion value of the actual damage state data thus received and the data indicating the common social value thus converted again.

16. The disaster evaluation method according to claim 14, further comprising:
receiving disaster occurrence information indicating a scale and an occurrence location of the disaster after the disaster occurs; and
performing the simulations of the damage states for the plural types of events, based on the disaster occurrence information thus received.

17. The disaster evaluation method according to claim 10, wherein
in a case where the disaster is a disaster caused by an earthquake and a subsequent tsunami, the damage caused by the disaster includes building and facility damage in a flooded area, history and social asset damage, physical distribution and economic activity damage, and human damage.

18. The disaster evaluation method according to claim 17, further comprising:
storing data of a building and a social infrastructure each having a specific added value, wherein the plurality of simulations includes at least a road building damage simulation to perform a simulation of a damage state of a road and a building, and an infrastructure damage simulation to simulate a damage state of a social infrastructure; and
performing the simulations of the damage states in consideration of the specific added value on the building and the social infrastructure each having the stored specific added value.

19. A non-transitory storage medium storing a program causing a computer to execute:
processing of respectively performing, in response to occurrence of a disaster, simulations of damage states for plural types of events caused by the disaster;
processing of converting data indicating the damage state as each of simulation results into data indicating a common social value; and
processing of evaluating a change in a social value that is caused by the disaster, based on plural pieces of the converted data of the plurality of simulation results.
